(19) United States
(12) Patent Application Publication
(10) Pub. No.: US 2023/0408240 A1
(43) Pub. Date: Dec. 21, 2023

(54) TRIM SQUARE WITH POSITIONABLE BASE

(71) Applicant: Apex Brands, Inc., Apex, NC (US)

(72) Inventors: Brendan Walsh, Holly Spring, NC (US); KEVIN Fitzpatrick, Apex, NC (US)

(21) Appl. No.: 18/035,547

(22) PCT Filed: Nov. 2, 2021
(86) PCT No.: PCT/US2021/057690

§ 371 Date: May 5, 2023

Related U.S. Application Data
(60) Provisional application No. 63/110,065, filed on Nov. 5, 2020.

(51) Int. Cl. G01B 5/245; B43L 7/02

(52) U.S. Cl. CPC G01B 5/245; B43L 7/02

(57) ABSTRACT

A trim square may include abase and a triangular main body defined by a first leg and a second leg that form a right angle at an intersection therebetween, and a third leg extending between distal ends of the first and second legs. The base may be operably coupled to the main body via a retention element at one of the first leg or the second leg. The main body may extend in a first plane, and the base may extend in a second plane substantially perpendicular to the first plane. The base may be movable relative to the main body in the second plane.

### TECHNICAL FIELD

Example embodiments generally relate to hand tools and, in particular, relate to a trim square with an adjustable or positionable base.

### BACKGROUND

Typical trim squares are used throughout construction industries. Trim squares usually include a metal plate in the shape of a right triangle with a T bar on one or two sides of the plate. The plate is embossed or otherwise marked with one or more measurement 15 markings, such as length, angles, and the like, such that a craftsman may set the square T bar at a position on a working material and use the measurement markings to quickly measure and mark angles, lines, or the like. The measurements and angle markings may be used for cutting the material in the desired shape and size.

Trim squares are manufactured in a variety of materials and sizes to accommodate the 20 breadth of environments and uses in which trim squares are utilized. However, craftsman may have to switch between multiple sizes of trim squares, such as when working on different sized working materials, which may slow production or be tedious for the craftsman.

### BRIEF SUMMARY OF SOME EXAMPLES

According to some example embodiments, a trim square (also known as a rafter square) may be provided. The trim square may include a base and a triangular main body defined by a first leg and a second leg that form a right angle at an intersection therebetween, and a third leg extending between distal ends of the first and second legs. The base may be operably coupled to the main body via a retention element at one of the first leg or the second leg. The main body may extend in a first plane, and the base may extend in a second plane substantially perpendicular to the first plane. The base may be movable relative to the main body in the second plane.

According to another example embodiment, a trim square may be provided to include a base and a triangular main body defined by a first leg and a second leg that form a right angle at an intersection therebetween, and a third leg extending between distal ends of the first and second legs. The base may be operably coupled to the main body via a magnetic retention element at one of the first leg or the second leg. The main body may extend in a first plane, and the base may extend in a second plane substantially perpendicular to the first plane.

### BRIEF DESCRIPTION OF THE SEVERAL VIEWS OF THE DRAWING(S)

Having thus described the tool in general terms, reference will now be made to the accompanying drawings, which are not necessarily drawn to scale, and wherein:

FIG. 1 illustrates a perspective view of a trim square (or rafter square) according to an example embodiment;

FIG. 2 illustrates an exploded perspective view of the trim square according to an example embodiment;

FIG. 3 illustrates a side view of the trim square with the base centered on a main body of the trim square according to an example embodiment;

FIG. 4 illustrates a side view of the trim square with uneven overhang portions according to an example embodiment;

FIG. 5 illustrates a side view of the trim square with overhang only on one side of the main body according to an example embodiment;

FIG. 6 illustrates a variety of different replacement bases according to an example embodiment;

FIG. 7 illustrates an alternative type of retention element in accordance with an example embodiment;

FIG. 8 illustrates a perspective view of a trip square with a different retention strategy for retaining the base in accordance with an example embodiment; and

FIG. 9 is a perspective view of a retention element of the example of FIG. 8 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. As used herein, operable coupling should be understood to relate to direct or indirect connection that, in either case, enables functional interconnection of components that are operably coupled to each other.

A trim square (or rafter square) typically has a fixed T bar portion that forms the base of one side the trim square. The corresponding side is often one leg of a right triangle formed by the metallic body of the trim square, and each leg and the hypotenuse of the right triangle may possibly have markings thereon for enabling the user to make measurements and mark the workpiece accordingly. The T bar portion is therefore often used either as a base upon which the entire weight of the trim square may be supported, or as a guide that rides along the edge of a medium or workpiece that is being measured (or that forms a reference for measurement). The T bar portion itself can not only be used as a reference for making and marking measurements with the sides of the trim square, but the length of the T bar portion that extends along the side of the workpiece (i.e., the amount of the width of the T bar portion that extends away from the metallic body) can also be used to scribe along the thickness of the workpiece. This is often used to scribe half thicknesses for pieces of lumber. Thus, for example, if the T bar portion extends ¼ inch or ⅜ inch perpendicularly away from the metallic body, the user can scribe across the thickness of a piece of lumber to form a half thickness scribe line for lumber of ½ inch or ¾ inch at a thickness of either ¼ inch or ⅜ inch, respectively.

As noted above, it is not uncommon for trim squares of different sizes to be employed in different situations. This is, at least in part, due to the limitations of the fixed T bar portion that are inherent in the typical trim square. In this regard, the ability to scribe across the thickness of the piece of lumber described above is fixed with the amount of the width of the T bar portion that extends away from the metallic body in most situations. Even if the T bar was made to have two different amounts of extension (e.g., having a ¼ inch extension on one side and a ⅜ inch extension on the other side), the problem of a fixed extension element persists, and the number of trim squares needed to cover all possible widths, although perhaps halved, still remains.

To address this issue, example embodiments may provide a variable width T bar portion that allow the amount of the T bar portion's width that is extended to either side of the metallic body to be adjustable. Moreover, for some embodiments, the T bar portion itself may be replaceable to have different characteristics to thereby provide further flexibility for the user. As a result, all desirable amounts of extension away from the metallic body may be achievable in a single adjustable or modifiable structure. The trim square (or rafter square) of example embodiments may therefore provide a square with a ruler or other base member that is magnetically held to the main body of the square perpendicular to the body of the square (so the base is removable and/or moveable relative to the body). Alternatively or additionally, the trim square (or rafter square) of example embodiments may provide a perpendicular base on a square that can be moved side to side in a plane perpendicular to the plane of the main body (e.g., where other retention means may be used instead of or in addition to magnets that allow side to side sliding of the base and fixing in a desired side-to-side position).

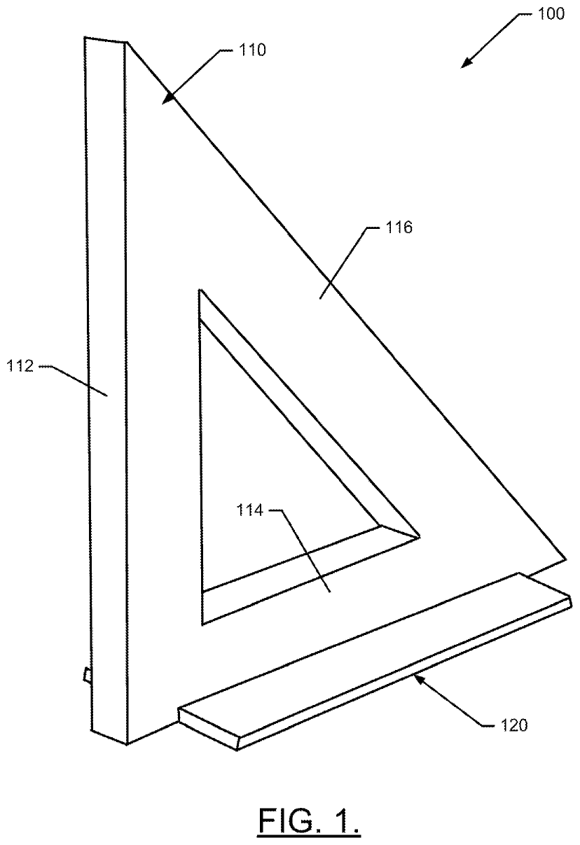

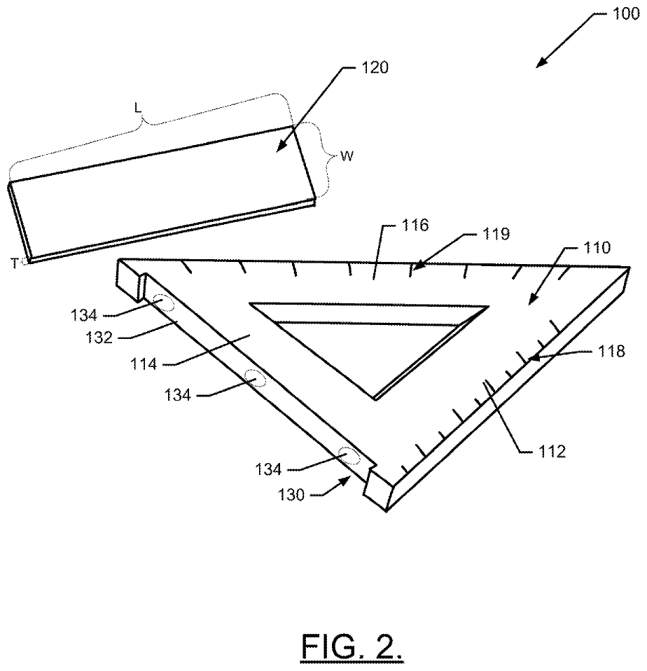

FIG. 1 illustrates a perspective view of a trim square 100 that includes a main body 110 and a base 120 (or base portion). FIG. 2 illustrates an exploded view of the trim square 100 such that the base 120 is removed from the main body 110. The main body 110 is a substantially triangular shaped, planar or flat plate. The main body 110 may be, in some cases, more particularly be formed in the shape of a right triangle. Accordingly, the main body 110 may include a first leg 112 and a second leg 114 that may extend perpendicularly away from each other. Thus, the intersection of the first and second legs 112 and 114 may form a right angle. A third leg 116 of the main body 110 may form a hypotenuse of the right triangle formed by the main body 110.

In the example of FIGS. 1 and 2, the main body 110 may be hollowed out at a center portion thereof (i.e., in a middle portion of the main body 110 between the first, second and third legs 112, 114 and 116). However, the main body 110 may not be hollowed in the center in other embodiments. In some example embodiments, the main body 110 may be formed from aluminum, steel, plastic, or the like. In an example embodiment, the main body 110 may include measurement markings disposed along outer surfaces of one or more outer edges of the right triangle that form the main body 110. As such, for example, measurement markings may be provided along the outer edge of any or all of the first, second and third legs 112, 114 and 116. In some example, the measurement markings made along the first leg 112 or the second leg 114 may include length measurement markings 118 defined in standard units (e.g., cm or in). When both the first leg 112 and the second leg 114 have length measurement markings 118, the length measurement markings 118 on each respective one of the first and second legs 112 and 114 may use the same or different units. Meanwhile, the third leg 116 may include angle measurement markings 119 (e.g., from 0 to 90 degrees, or a portion of a scale from 0 to 90 degrees). The measurement markings may be printed, embossed, inscribed, or otherwise indicated on the main body 110.

The base 120 may be attachable to or removable from the main body 110 of the trim square 100. More specifically, the base 120 may be attachable to one of either the first leg 112 of the second leg 114 of the main body 110. In this example, the base 120 is attachable to the second leg 114. When attached, the base 120 may form a T bar or base portion relative to the remainder of the main body 110. The base 120 may be a substantially flat and rectangular shaped plate having a length (L), a width (W) and a thickness (T). Although the base 120 in the example of FIGS. 1 and 2 has a smaller thickness than a thickness (Tb) of the main body 110, the thicknesses could alternatively be the same or even reversed (i.e., the base 120 could be thicker than the main body 110).

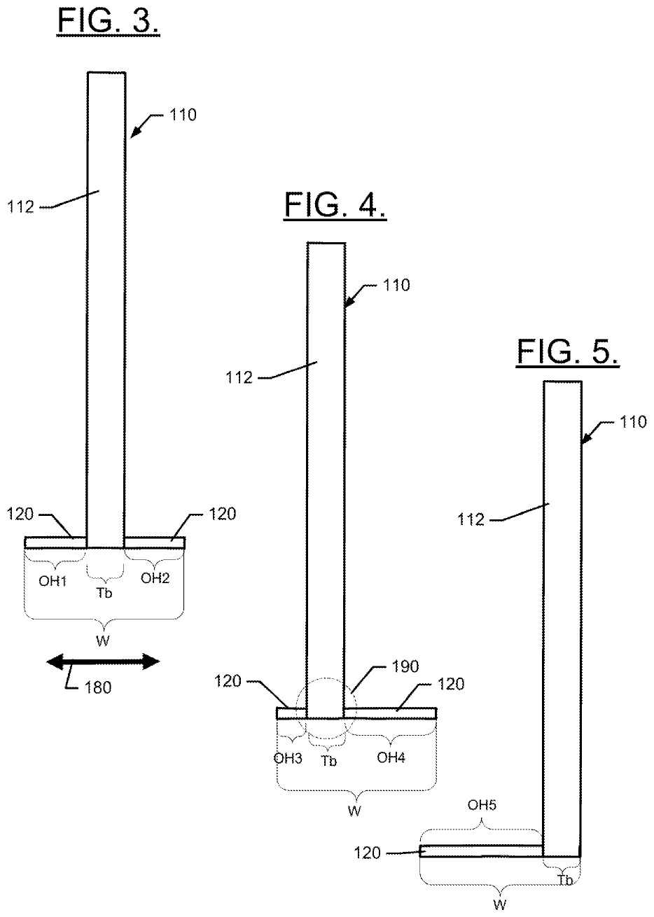

The base 120 may attach to the second leg 114 such that a plane in which the base 120 lies (or a plane of the face of the base 120 that contacts the second leg 114) is substantially perpendicular to a plane in which the main body 110 lies (or a plane of a face of the second leg 114 that contacts the base 120). Moreover, the width (W) of the base 120 may be larger than the thickness (Tb) of the main body 110. Thus, the base 120 may form the top of a T shape when attached to the second leg 114 relative to the main body 110. The fact that the base 120 is wider than the thickness (Tb) of the main body 110 may ensure that the trim square 100 may be set up to stand vertically (so that the first leg 110 is substantially perpendicular to a supporting surface on which the base 120 rests) as shown in FIGS. 3-5.

In an example embodiment, the length (L) of the base 120 may be less than a length of the second leg 114. In such examples, a reception groove 130 may be formed in the second leg 114. The reception groove 130 may have a length that is substantially equal to the length (L) of the base 120, and a depth (extending into the second leg 114) that is substantially equal to the thickness (T) of the base 120 so that the base 120 fits with the reception groove 130 and is flush with the portions of the second leg 114 that extend beyond the length (L) of the base 120. However, in some cases, the length (L) of the base 120 may be substantially equal to the length of the second leg 114. In such examples, there may be no reception groove 130 formed.

In examples where the second leg 114 is longer than the length (L) of the base 120, the reception groove 130 may be formed to include retention elements that facilitate holding the base 120 in the reception groove 130. The retention elements may take numerous different forms. For example, a contact face 132 of the reception groove 130 (e.g., a portion of the reception groove 130 that contacts the top face of the base 120) may have magnets 134 disposed therein. The magnets 134 may attract magnets disposed in the base 120 or may attract the base 120 itself (e.g., when the base 120 is metallic and made of ferrous or magnetic material). In an example embodiment, regardless of the specific form of the retention elements, the base 120 may be moveable relative to the main body 110. The movement may be of the base 120 such that the alignment of the base 120 and the main body 110 is altered while the base 120 remains perpendicular to the direction of extension of the main body 110. In other words, the base 120 may move so that a different portion of the width (W) of the base 120 is aligned with the main body 110. FIGS. 3-5 illustrate several possible different alignments.

In this regard, FIG. 3 illustrates an example in which a longitudinal center portion of the base 120 is aligned with the main body 110. As such, portions of the base 120 that overhang or extend perpendicularly away from each opposing side of the main body 110 are substantially equal. A first overhang region having a width (OH1) therefore has a same width as a width (OH2) of a second overhang region. In other words, the base 120 is provided in the reception groove 130 in such a way as to provide equal amounts of overhang of the base 120 on both opposing sides of the main body 110. The width (OH1), width (OH2) and the thickness of the base (Tb) combine to equal the width (W) of the base 120.

The base 120 may alternatively be disposed in the reception groove 130 such that the amounts of overhang on each side of the main body 110 are not equal. FIG. 4 illustrates such an example. In this regard, as shown in FIG. 4, portions of the base 120 that overhang or extend perpendicularly away from each opposing side of the main body 110 are not equal. A third overhang region having a width (OH3) therefore smaller in width than a width (OH4) of a fourth overhang region. In other words, the base 120 is provided in the reception groove 130 in such a way as to provide unequal amounts of overhang of the base 120 on both opposing sides of the main body 110. The width (OH3), width (OH4) and the thickness of the base (Tb) combine to equal the width (W) of the base 120.

The base 120 may alternatively be disposed in the reception groove 130 such that there is no overhang on one side of the main body 110. FIG. 5 illustrates such an example. In this regard, as shown in FIG. 4, a portion of the base 120 is positioned to overhang or extend perpendicularly away from only one side of the main body 110. As such, a fifth overhang region having a width (OH5) is only provided on one side of the main body 110. The width (OH5) and the thickness of the base (Tb) combine to equal the width (W) of the base 120.

As can be appreciated from FIGS. 3-5, the base 120 can be slid perpendicularly (relative to the plane of the main body 110) in the direction of double arrow 180 to achieve any desired alignment between the base 120 and the main body 110, and therefore also any desired amount of overhang of the base 120 on each side of the main body 110. This may allow the user to define a scribe line to be drawn across the thickness of a piece of lumber (or other workpiece) at any desirable depth from a corresponding side of the piece of lumber. Typical standard measurements such as ⅜, ¼, ½ inch or the like may therefore be easily selected and defined by the user simply by sliding the base in one of the directions shown by double arrow 180 to obtain the desired amount of overhang on one side of the main body 110.

For example, if the desired amount of overhang is ⅜ inch, and the width (W) of the base is one inch, whereas the thickness (Tb) of the main body 110 is ¼ inch, then OH1 and OH2 may each be set to ⅜ inch as shown in FIG. 3. However, if the desired amount of overhang is ¼ inch, then the main body 110 may be slid to define the OH3 as ¼. In such an example (with the width (W) of the main body 110 still being 1 inch), OH4 will be ½ inch as shown in FIG. 4. If instead, the amount of overhang is desired to be ¾ inch, then the example of FIG. 5 may be followed, and the base 120 may be slid to define OH5 to be equal to ¾ inch. Of course, the scale of any of the components discussed above may be changed to provide different options as well.

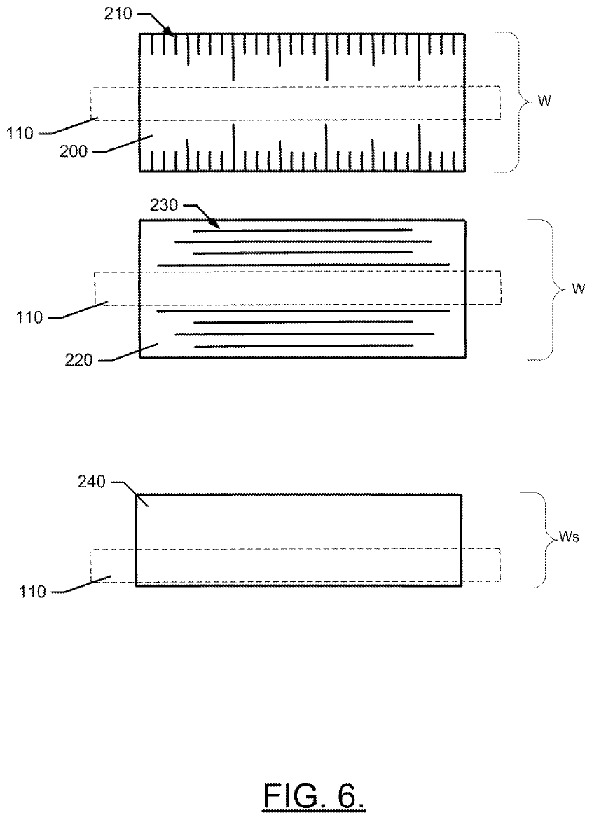

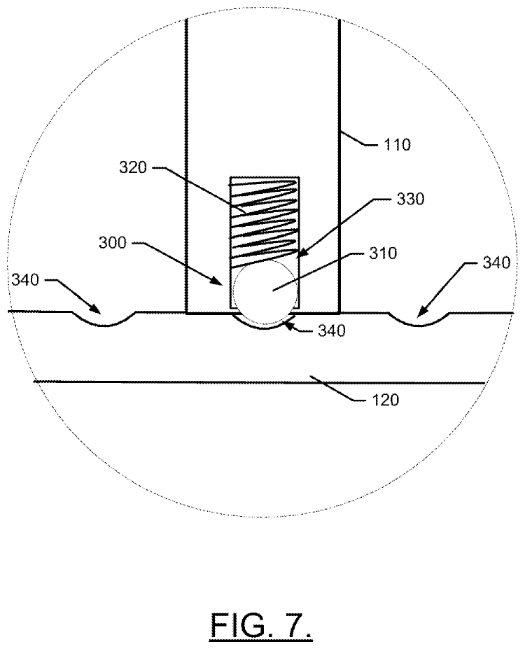

Because the base 120 is removable, it may be possible to replace the base 120 with other bases that may differ over any of a variety of characteristics. FIG. 6 illustrates a series of bases with different characteristics according to an example embodiment. In this regard, FIG. 6 illustrates a first base 200 having length measurement markings 210 disposed thereon. The first base 200 is shown relative to the main body 110 (which is shown in dashed lines). A second base 220 is also shown with different characteristics. In this regard, the second base 220 differs from the first base 200 by virtue of the measurement characteristics associated with the measurement markings. Whereas the first base 200 includes the length measurement markings 210, which are configured to facilitate measurement along the length (L) of the first base 200, the second base 220 has width measurement markings 230, which may be configured to facilitate measurement along the width (W) of the second base 220.

The first base 200 and the second base 220 therefore differ from each other on the basis of measurement markings, and more specifically on the basis of the measurement paradigm supported by the measurement markings provided on each respective base. However, other differences may alternatively (or additionally) be provided. For example, a third base 240 is shown, which differs from each of the first and second bases 200 and 220 in terms of size. In this regard, whereas the first and second bases 200 and 220 each have the same dimensions in terms of length (L) and width (W) (and presumably also thickness, which is not shown), the third base 240 has a smaller width (Ws) than the width (W) of the first and second bases 200 and 220.

FIG. 7 illustrates cross section view of portion 190 of FIG. 4 with an alternative retention element 300 (relative to the magnetic retention element shown in FIG. 2). The example retention element 300 of FIG. 6 may be defined by a protruding element 310 (e.g., a ball) that is biased (e.g., by spring 320) to extend out of a retention well 330 formed in the main body 110. The retention well 330 may house the protruding element 310 and the spring 320 may urge the protruding element 310 to engage with a depression 340 formed in a surface of the base 120. The depression 340 may be one of a series of depressions 340 formed in the surface of the base 120. When the protruding element 310 aligns with one of the depressions 340, the protruding element 310 may extend into the corresponding one of the depressions 340 and hold the base 120 and main body 110 in the corresponding alignment. However, sliding force exerted by the user may overcome the biasing force of the spring 320 to enable the protruding element 310 to be slid until the next depression 340 is encountered. In such an example, the longitudinal ends of the base 120 may be retained in the reception groove 130 by a tongue-in-groove retaining structure formed at portions of the second leg 114 that engage longitudinal ends of the base 120. Still other example retention elements are also possible for substitution from the magnetic retention element shown in FIG. 2.

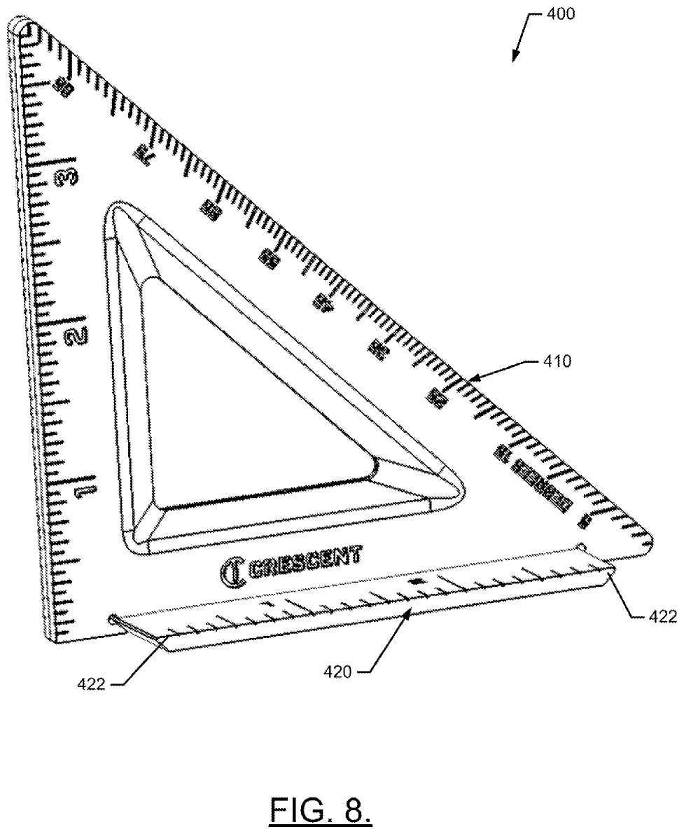

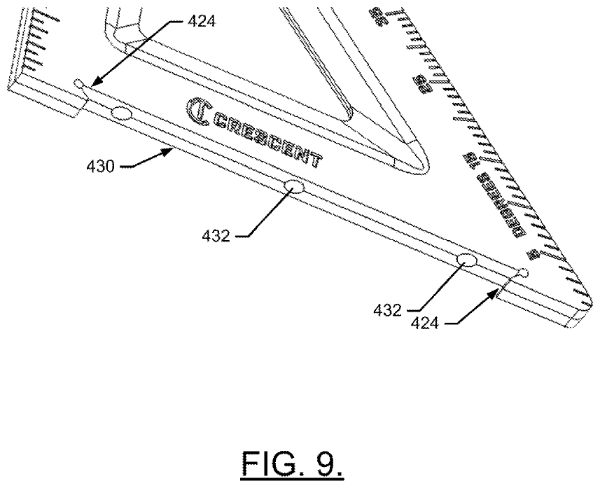

FIG. 8 illustrates a perspective view of a trip square with a different retention strategy for retaining the base in accordance with an example embodiment. In this regard, trim square 400 includes a main body 410 and a base 420 that are similar to the examples described above except with respect to the retention strategy for retaining the base 420 in the main body 410. In this regard, the base 420 and main body 410 employ a tongue in groove style retention assembly. More particularly, the main body 410 may include a reception groove 430 (e.g., formed in a second leg of the base 420). As discussed above, the reception groove 430 may have a length that is substantially equal to the length of the base 420, and a depth (extending into the second leg) that is substantially equal to the thickness of the base 420 so that the base 420 fits with the reception groove 430 and is flush with the portions of the second leg that extend beyond the length of the base 420. However, in this example opposing longitudinal ends of the base 420 may have a triangular or other shaped tongue or shaped projection 422. Meanwhile, the longitudinal ends of the reception groove 430 may have shaped receivers 424 that are complementary to the shaped projections 422 of the base 420. The shaped receivers 424 may retain the base 420 in the reception groove 430, but permit sliding of the base 420 relative to the reception groove 430.

Although not required, the reception groove 430 may also include magnet receptacles inside which magnets 432 may be retained. The magnets 432 (if employed) may resist sliding of the base 420 within the reception groove 430. FIG. 9 shows the magnets 432 due to removal of the base 420 from the reception groove 430.

According to some example embodiments, a trim square (also known as a rafter square) may be provided. The trim square may include a base and a triangular main body defined by a first leg and a second leg that form a right angle at an intersection therebetween, and a third leg extending between distal ends of the first and second legs. The base may be operably coupled to the main body via a retention element at one of the first leg or the second leg. The main body may extend in a first plane, and the base may extend in a second plane substantially perpendicular to the first plane. In some cases, the retention element may be a magnetic retention element. Alternatively or additionally, the base may be movable relative to the main body in the second plane.

In some embodiments, the trim square may be further configured for optional modifications. In this regard, for example, the base may have a length, width and thickness. The second leg may be longer than the length of the base and may include a reception groove substantially equal in length to the length of the base. The reception groove may have a depth substantially equal to a thickness of the base, and the width of the base may be greater than a thickness of the main body. In an example embodiment, the retention element may include one or more magnets. In some cases, the base may be made of ferromagnetic material, and the one or more magnets may be disposed in the second leg at the reception groove. In an example embodiment, the base may be removable relative to the main body. In some cases, the base may be replaceable with a replacement base that is different than the base. In an example embodiment, the base may have a different set of measurement markings than the replacement base. In some cases, the replacement base may have a different width than the width of the base. In an example embodiment, the base may be configured to be fixed relative to the main body such that a first portion of the base extends perpendicularly away from a first side of the main body, and a second portion of the base extends perpendicularly away from a second side of the main body. In some cases, the first and second portions may have adjustable lengths that are either both the same or different from each other.

Many modifications and other embodiments of the examples set forth herein will come to mind to one skilled in the art to which these inventions pertain having the benefit of the teachings presented in the foregoing descriptions and the associated drawings. Therefore, it is to be understood that the example embodiments are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A trim square comprising:
a triangular main body defined by a first leg and a second leg that form a right angle at an intersection therebetween, and a third leg extending between distal ends of the first and second legs; and
a base operably coupled to the main body via a retention element at one of the first leg or the second leg,
wherein the main body extends in a first plane, and the base extends in a second plane substantially perpendicular to the first plane, and
wherein the base is movable relative to the main body in the second plane.

2. The trim square of claim 1, wherein the base has a length, width and thickness,
wherein the second leg is longer than the length of the base and comprises a reception groove substantially equal in length to the length of the base,
wherein the reception groove has a depth substantially equal to a thickness of the base, and
wherein the width of the base is greater than a thickness of the main body.

3. The trim square of claim 2, wherein the retention element comprises one or more magnets.

4. The trim square of claim 3, wherein the base is made of ferromagnetic material, and
wherein the one or more magnets are disposed in the second leg at the reception groove.

5. The trim square of claim 1, wherein the base is removable relative to the main body.

6. The trim square of claim 5, wherein the base is replaceable with a replacement base that is different than the base.

7. The trim square of claim 6, wherein the base has a different set of measurement markings than the replacement base, or
wherein the replacement base has a different width than the width of the base.

8. The trim square of claim 1, wherein the retention element comprises a shaped protrusion at least one longitudinal end of the base and a shaped receiver formed at a reception groove in the base, the shaped receiver being shaped to conform to the shaped protrusion.

9. The trim square of claim 1, wherein the base is configured to be fixed relative to the main body such that a first portion of the base extends perpendicularly away from a first side of the main body, and a second portion of the base extends perpendicularly away from a second side of the main body.

10. The trim square of claim 9, wherein the first and second portions have adjustable lengths that are either both the same or different from each other.

11. A trim square comprising:
a triangular main body defined by a first leg and a second leg that form a right angle at an intersection therebetween, and a third leg extending between distal ends of the first and second legs; and
a base operably coupled to the main body via a magnetic retention element at one of the first leg or the second leg,
wherein the main body extends in a first plane, and the base extends in a second plane substantially perpendicular to the first plane.

12. The trim square of claim 11, wherein the base has a length, width and thickness,
wherein the second leg is longer than the length of the base and comprises a reception groove substantially equal in length to the length of the base,
wherein the reception groove has a depth substantially equal to a thickness of the base, and
wherein the width of the base is greater than a thickness of the main body.

13. The trim square of claim 12, wherein the magnetic retention element comprises one or more magnets.

14. The trim square of claim 13, wherein the base is made of ferromagnetic material, and
wherein the one or more magnets are disposed in the second leg at the reception groove.

15. The trim square of claim 11, wherein the base is removable relative to the main body.

16. The trim square of claim 15, wherein the base is replaceable with a replacement base that is different than the base.

17. The trim square of claim 16, wherein the base has a different set of measurement markings than the replacement base.

18. The trim square of claim 16, wherein the replacement base has a different width than the width of the base.

19. The trim square of claim 18, claim 1, wherein the base is configured to be fixed relative to the main body such that a first portion of the base extends perpendicularly away from a first side of the main body, and a second portion of the base extends perpendicularly away from a second side of the main body.

20. The trim square of claim 19, wherein the first and second portions have adjustable lengths that are either both the same or different from each other.
